(19) United States
(12) Patent Application Publication
(10) Pub. No.: US 2013/0151878 A1
(43) Pub. Date: Jun. 13, 2013

(54) INFORMATION PROCESSING APPARATUS WITH FUNCTION TO SOLVE FRAGMENTATION ON MEMORY, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Takaaki MIYATA, Tokyo (JP)

(73) Assignee: CANON KABUSHIKI KAISHA, Tokyo (JP)

(21) Appl. No.: 13/710,693

(22) Filed: Dec. 11, 2012

(30) Foreign Application Priority Data
Dec. 12, 2011 (JP) 2011-271128

(51) Int. Cl. G06F 1/32

(52) U.S. Cl. CPC G06F 1/3237
USPC 713/321

(57) ABSTRACT

An information processing apparatus that is capable of reducing fragmentation of use areas on a memory and of shortening waiting time. The information processing apparatus has a volatile first memory and a nonvolatile second memory. A first control unit starts the information processing apparatus without using a hibernation image when a hibernation image is not stored in the second memory at the time of starting the information processing apparatus, and generates a hibernation image in the second memory. A second control unit starts the information processing apparatus while using a hibernation image when the hibernation image is stored in the second memory at the time of starting the information processing apparatus. A third control unit changes a state of the information processing apparatus to a power saving state while keeping power supply to the first memory in response to completion of the starting of the information processing apparatus.

### BACKGROUND OF THE INVENTION

1. Field of the Invention

The present invention relates to an information processing apparatus with a function to solve fragmentation on a memory, a control method therefor, and a storage medium storing a control program therefor.

2. Description of the Related Art

An image forming apparatus like a multifunction printer that is provided with a copy function and a facsimile function operates continuously for a long time in general. In the image forming apparatus that operates continuously for a long time, use areas fragmented on a memory increase as the number of memory accesses by applications that achieve functions increases.

Accordingly, even when a system tries to secure a continuous memory area, it cannot secure or it takes long time to secure, which may cause a fault in an operation of an application.

In order to solve the above-mentioned problem, there is a method to refresh a memory by rebooting an apparatus periodically while the apparatus is in a sleep mode (for example, see Japanese Laid-Open Patent Publication (Kokai) No. 2006-229509 (JP 2006-229509A)).

However, when the method of rebooting periodically is used, an image forming apparatus may be performing the rebooting process even if a user tries to use the apparatus. In this case, the user cannot use the image forming apparatus until the rebooting process is completed. Particularly, since some image forming apparatuses in recent years need long time for a boot process, a user may be required to wait for long time.

### SUMMARY OF THE INVENTION

The present invention provides an information processing apparatus, a control method therefor, and a storage medium storing a control program therefor, which are capable of reducing fragmentation of use areas on a memory used by an image process, and of shortening waiting time for a user who uses the image processing apparatus.

Accordingly, a first aspect of the present invention provides an information processing apparatus that has a volatile first memory and a nonvolatile memory, comprising a first control unit configured to start the information processing apparatus without using a hibernation image when a hibernation image is not stored in the second memory at the time of starting the information processing apparatus, and to generate a hibernation image in the second memory, a second control unit configured to start the information processing apparatus while using a hibernation image when the hibernation image is stored in the second memory at the time of starting the information processing apparatus, and a third control unit configured to change a state of the information processing apparatus to a power saving state while keeping power supply to the first memory in response to completion of the starting of the information processing apparatus.

Accordingly, a second aspect of the present invention provides a control method for an information processing apparatus that has a volatile first memory and a nonvolatile memory, comprising a first control step of starting the information processing apparatus without using a hibernation image when a hibernation image is not stored in the second memory at the time of starting the information processing apparatus, and of generating a hibernation image in the second memory, a second control step of starting the information processing apparatus while using a hibernation image when the hibernation image is stored in the second memory at the time of starting the information processing apparatus, and a third control step of changing a state of the information processing apparatus to a power saving state while keeping power supply to the first memory in response to completion of the starting of the information processing apparatus.

Accordingly, a third aspect of the present invention provides a non-transitory computer-readable storage medium storing a control program causing a computer to execute the control method of the second aspect.

According to the present invention, the fragmentation of use areas on a memory used by an image process can be controlled, and the waiting time for a user who uses the information processing apparatus can be shortened.

Further features of the present invention will become apparent from the following description of exemplary embodiments with reference to the attached drawings.

### BRIEF DESCRIPTION OF THE DRAWINGS

FIG. 1 is a block diagram schematically showing a configuration of an image forming apparatus according to a first embodiment of the present invention.

FIG. 2 is a block diagram schematically showing a configuration of a controller in FIG. 1.

FIG. 3 is a block diagram schematically showing configurations of a power control system and reset circuits of the controller in FIG. 1.

FIG. 4 is a block diagram schematically showing a configuration of a power supplying section of the image forming apparatus shown in FIG. 1.

FIG. 5 is a view showing power supply to the controller when the image forming apparatus shown in FIG. 1 makes a transition to a quick-off state.

FIG. 6 is a flowchart showing a state discrimination process executed by the controller in FIG. 1.

FIG. 7 is a flowchart showing a boot process executed in step S407 in FIG. 6.

FIG. 8A through FIG. 8D are views showing electric power states of the image forming apparatus when a power switch is ON and OFF, respectively.

FIG. 9A, FIG. 9B, and FIG. 9C are timing charts showing a process performed in response to ON/OFF operations of the power switch.

### DESCRIPTION OF THE EMBODIMENTS

Hereafter, embodiments according to the present invention will be described in detail with reference to the drawings. It should be noted that an image forming apparatus to which the information processing apparatus of the present invention is applied will be described in this embodiment.

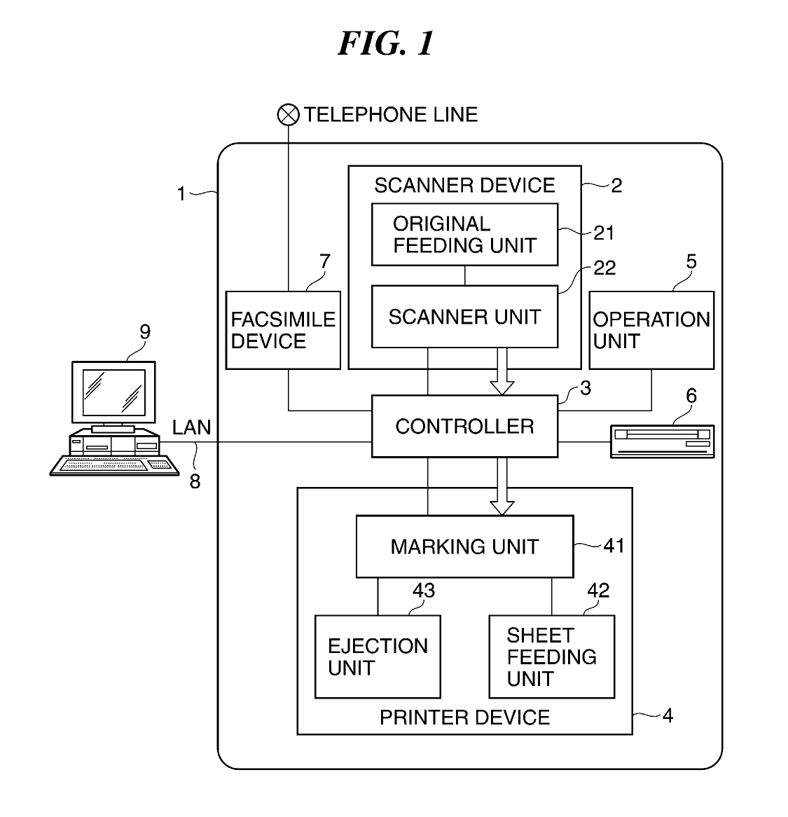

FIG. 1 is a block diagram schematically showing a configuration of the image forming apparatus 1 according to the embodiment of the present invention.

As shown in FIG. 1, the image forming apparatus 1 comprises a controller 3, a scanner device 2, a printer device 4, an operation unit 5, a hard disk 6 (a nonvolatile storage unit), and a facsimile device 7.

The controller 3 controls the entire image forming apparatus 1. The configuration of the controller 3 will be described later.

The scanner device 2 reads an image of an original optically, and converts it into a digital image. The scanner device 2 is provided with an original feeding unit 21 that automatically feeds originals from an original bundle one-by-one, and a scanner unit 22 that scans an original optically and converts it into a digital image. Then, the digital image converted by the scanner device 2 is transmitted to the controller 3.

The printer device 4 prints a digital image onto a recording sheet. The printer device 4 is provided with a sheet feeding unit 42 that feeds recording sheets from a sheet bundle one-by-one, a marking unit 41 that prints image data on a recording sheet fed, and an ejection unit 43 that ejects the recording sheet after printing.

The operation unit 5 is used in order that a user operates the image forming apparatus 1. The hard disk 6 stores digital images, control programs, etc. The facsimile device 7 transmits a digital image to a destination device via a telephone line etc.

A computer 9 is connected with the image forming apparatus 1 via a LAN 8. The computer 9 exchanges a digital image with the image forming apparatus 1, issues a job, and controls the apparatus.

The image forming apparatus 1 can perform many functions, such as a copy function, an image transmitting function, an image storage function, and an image printing function.

The copy function stores a digital image converted by the scanner device 2 into the hard disk 6, and prints it by the printer device 4.

The image transmitting function transmits the digital image converted by the scanner device 2 to the computer 9 via the LAN 8.

The image storage function stores the digital image converted by the scanner device 2 into the hard disk 6, transmits the stored digital image as needed to print the digital image.

The image printing function analyzes page description language transmitted from the computer 9, and prints it by the printer device 4.

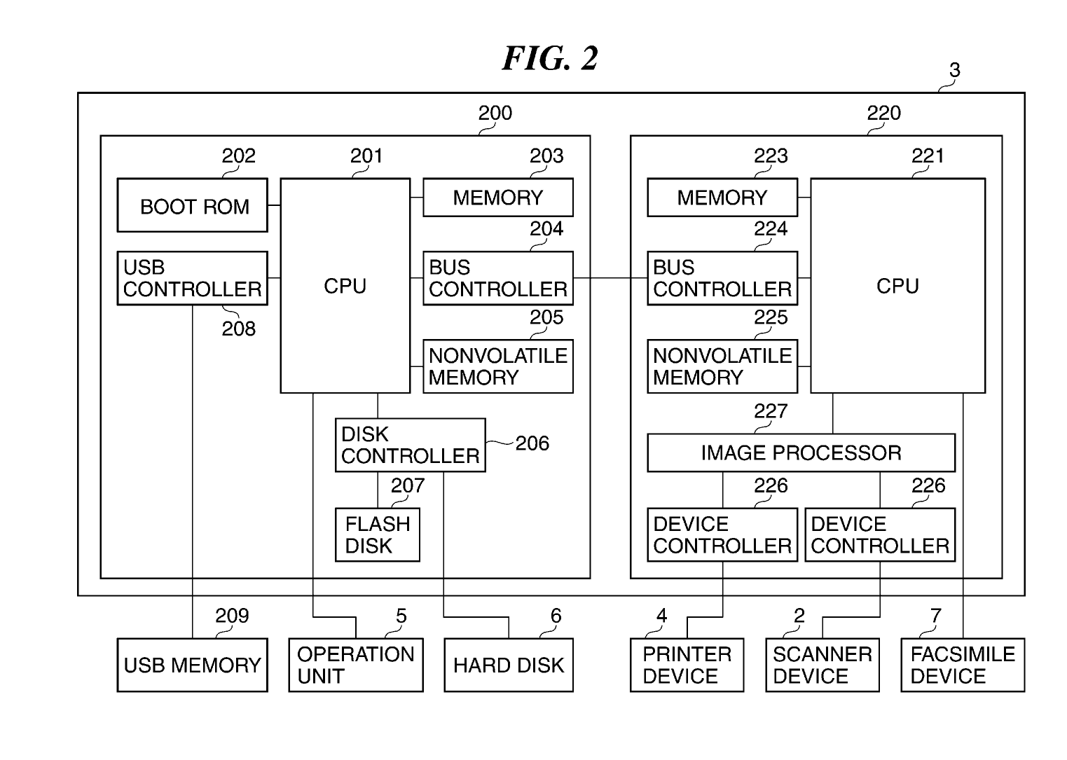

FIG. 2 is a block diagram schematically showing a configuration of the controller 3 in FIG. 1.

The controller 3 is provided with a mainboard 200 and an auxiliary board 220 as shown in FIG. 2.

The mainboard 200 is a general-purpose CPU system. In the mainboard 200, a CPU 201 controls the entire mainboard 200. A boot ROM 202 stores a boot program. A memory 203 is used by the CPU 201 as a work memory. A bus controller 204 has a bridge function with an external bus. A nonvolatile memory 205 holds memory contents, even if the power is cut off.

A disk controller 206 controls a storage unit. A flash disk 207 is a comparatively small capacity storage unit (an SSD etc.) that consists of semiconductor devices. A USB controller 208 controls USB communication.

The mainboard 200 is connected to an external USB memory 209, the operation unit 5, the hard disk 6, etc.

The auxiliary board 220 is a general-purpose CPU system of a comparatively small size. In the auxiliary board 220, a CPU 221 controls the entire auxiliary board 220. A memory 223 is used by the CPU 221 as a work memory. A bus controller 224 has a bridge function with the external bus. A nonvolatile memory 225 holds memory contents, even if the power is cut off.

An image processor 227 performs a real-time digital image process. Device controllers 226 transfer digital images between the devices (the scanner device 2 and the printer device 4) and the image processor 227. The facsimile device 7 is directly controlled by the CPU 221.

It should be noted that the outline configuration shown in FIG. 2 is simplified. For example, many pieces of peripheral hardware (a chip set, a bus bridge, a clock generator, etc.) of the CPU 201 and the CPU 221 are not shown.

Copy operation will be described as an operation example of the controller 3.

When a user instructs to copy an image from the operation unit 5, the CPU 201 sends an image reading command to the scanner device 2 via the CPU 221. The scanner device 2 optically scans an original, converts it into a digital image, and outputs the digital image to the image processor 227 via the device controller 226.

The image processor 227 performs a DMA transfer to the memory 223 via the CPU 221 to store the digital image temporarily.

When determining that digital images occupy a predetermined quantity or all the capacity of the memory 223, the CPU 201 issues an image output command to the printer device 4 via the CPU 221. The CPU 221 notifies the image processor 227 of the positions of the digital images in the memory 223.

A digital image stored in the memory 223 is transmitted to the printer device 4 via the image processor 227 and the device controller 226 according to a synchronized signal from the printer device 4, and the printer device 4 prints digital image data on a recording sheet.

When printing a plurality of copies, the CPU 201 transfers the digital images stored in the memory 223 to the hard disk 6. When printing the second and later copies, the digital images are transmitted to the printer device 4 from the hard disk 6 without operating the scanner device 2.

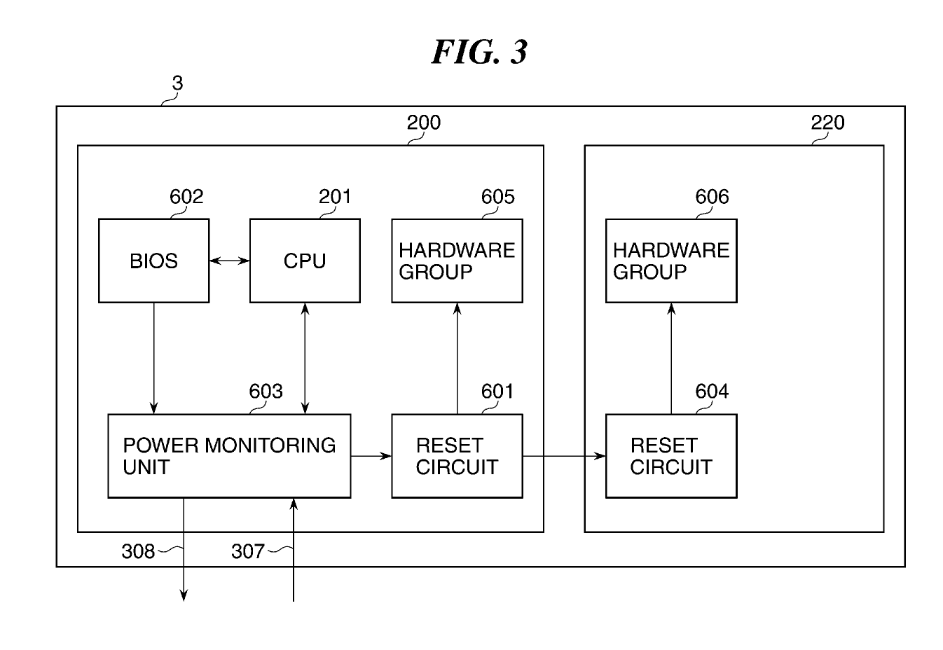

FIG. 3 is a block diagram schematically showing configurations of a power control system and reset circuits of the controller 3 in FIG. 1.

As shown in FIG. 3, the mainboard 200 includes a reset circuit 601, a BIOS 602, a power monitoring unit 603, and a hardware group 605. The BIOS 602 controls a fundamental section of the hardware of the mainboard 200. The power monitoring unit 603 is a custom hardware logic that monitors the power control of the image forming apparatus 1. The hardware group 605 shows hardware units on the mainboard 200 collectively.

On the other hand, the auxiliary board 220 includes a reset circuit 604 and a hardware group 606. The hardware group 606 shows hardware units on the auxiliary board 220 collectively.

Since synchronous hardware initializes an internal state by reset, the reset circuit must reset the synchronous hardware after turning the power ON and supplying electric power to each hardware unit.

Since a plurality of hardware units have a master-slave relation, they are sequentially reset according to a designed reset sequence. Accordingly, one board has one reset circuit as described in the embodiment in general, and each reset circuit performs a rest operation on the board concerned.

The mainboard 200 has a main role in the image forming apparatus 1, and has the power monitoring unit 603 as mentioned above. A state of a power switch is inputted into the power monitoring unit 603 via a line 307. The power monitoring unit 603 controls the power supply in the mainboard 200 using a power remote line 308.

When the CPU 201 can operate normally, the CPU 201 can instruct the image forming apparatus 1 to reset. When the power is not supplied to the CPU 201, the power of the controller 3 can be turned ON using the power remote line 308.

The BIOS 602 includes a low-level hardware control library, etc. The library can perform a part of power saving function according to the ACPI standard.

The ACPI-S3 system, which resumes a memory, will be described as an example of the power saving function of the embodiment. The BIOS 602 performs a part of function of the ACPI-S3 system. In the following description, a state where the power is supplied to a target A is expressed as “the target A is ON”, a state where the power is not supplied to the target A is expressed as “the target A is OFF”.

In the image forming apparatus 1, when a user turns OFF the power, the CPU 201 detects that the power was turned OFF by the power monitoring unit 603. That is, when detecting that the power supply was turned OFF, the CPU 201 performs a shutdown sequence, and instructs the power monitoring unit 603 to shut down.

As a result, the power OFF state is notified to a DC-AC converter mentioned later via the power remote line 308, and the image forming apparatus 1 is completely shut down by turning OFF DC power of the controller 3.

Since the shutdown finishes the program executed by the CPU 201 completely, the program of the CPU 201 will be normally started at the time of turning ON the power again.

Next, an operation of the ACPI-S3 suspension system in the embodiment will be described. When the CPU 201 calls a power-saving interface of an OS (Operating System), for example, the BIOS 602 and the power monitoring unit 603 finally make a transition to the ACPI-S3 state.

The CPU 201 can change a power supply unit mentioned later to the ACPI-S3 state via the power remote line 308. In this state, only the memory 203 and a part of the hardware units will be in an energized state.

At the time, since the image forming apparatus 1 is not in the power off state and holds the program in the memory, the program can be restarted in short time when this state will be cancelled by a predetermined external factor.

Thereby, the image forming apparatus 1 can shorten waiting time that is an interval until reaching the working state where operations such as copying are possible actually after a user turns ON the power. In order to distinguish in the description, the state where the power is not supplied to the image forming apparatus 1 is defined as a “power OFF state”, and the waiting state that keeps the energized state of the limited section including the memory 203 is defined as a “quick-off state”. Although the power consumption in the quick-off state is less than in the working state, the power is consumed slightly.

As a use-case of the image forming apparatus 1 in the embodiment, there may be a case where the image forming apparatus 1 is usually set in the quick-off state in order to shorten the waiting time, but is set in the power OFF state only in specific cases (a long leave etc.), for example.

For this reason, it is possible that a user selects a target state of a transition by setting by the user using the operation unit 5 beforehand, for example. A target state of a transition may be determined based on the internal condition of the image forming apparatus 1.

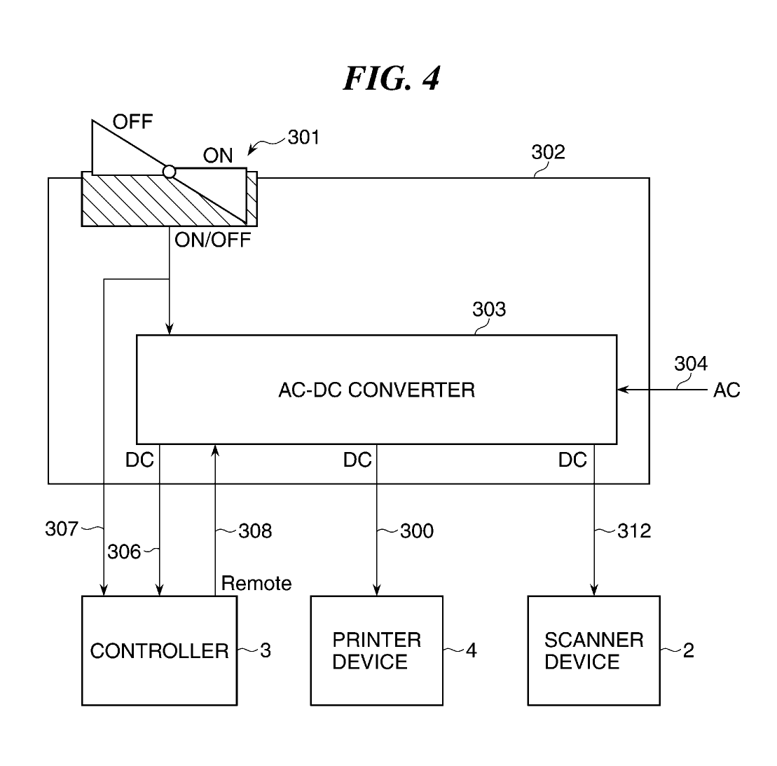

FIG. 4 is a block diagram schematically showing a configuration of a power supplying section of the image forming apparatus 1.

As shown in FIG. 4, a power supply unit 302 comprises a power switch 301 and an AC-DC converter 303.

The power switch 301 is a toggle switch that is operated by a user. The power switch 301 mechanically holds one of an ON state and an OFF state.

The AC-DC converter 303 converts AC power supplied via a power cable 304 into DC power, and distribute the DC power to the controller 3, the printer device 4, and the scanner device 2 via power cables 306, 300, and 312, respectively.

The power switch 301 is connected to the controller 3 via the line 307. The controller 3 transmits the power supply remote signal that controls the output of the AC-DC converter 303 to the AC-DC converter 303 via the power remote line 308.

The power switch 301 is connected to the AC-DC converter 303, and can control the energized state of the power supply unit 302.

It should be noted that the embodiment employs the toggle switch of which the OFF/ON state is explicit. However, the present invention is not limited to this, but can also use a push switch or the like that does not hold its state. When a switch that does not hold its state is used, an operation under a condition where the power is supplied to the apparatus corresponds to “OFF” of the toggle switch, and an operation under a condition where the power is not supplied to the apparatus corresponds to “ON” of the toggle switch.

In the case of a transition to the power OFF state, the power supply via the power cable 306 must not be stopped until the controller 3 completely shuts down. That is, the controller 3 detects the state of the power switch 301 via the line 307, and stops the power supplied through the power cable 306 using the power remote line 308 after the controller 3 completely shuts down.

On the other hand, the power supplied to the printer device 4 and the scanner device 2 via the power cables 300 and 312 is stopped when the power switch 301 is turned OFF.

When changing to the quick-off state, the power supplied to the printer device 4 and the scanner device 2 is stopped.

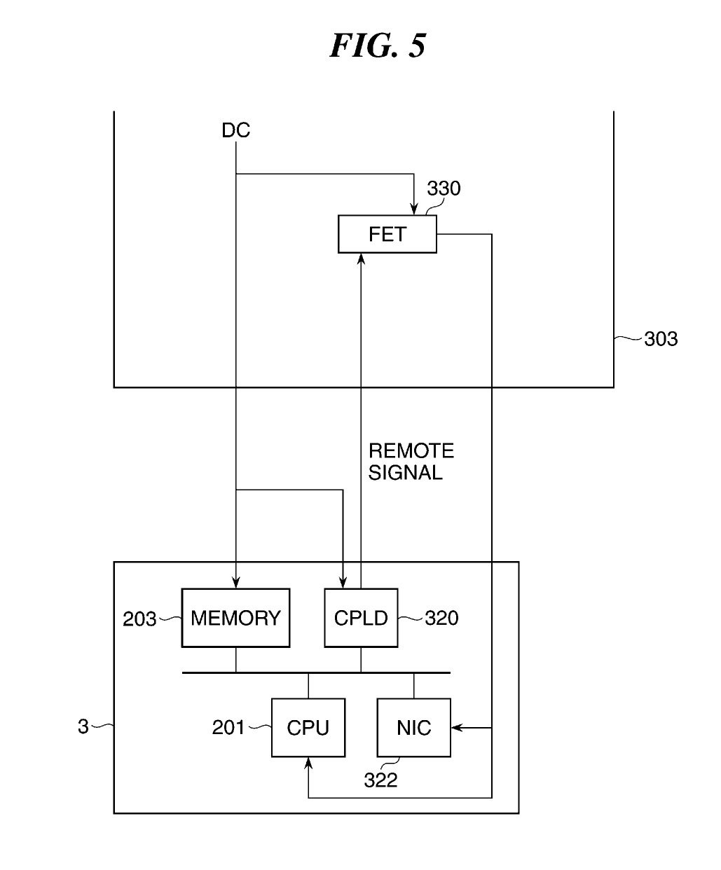

FIG. 5 is a view showing power supply to the controller 3 when the image forming apparatus 1 makes a transition to the quick-off state.

In FIG. 5, an FET 330 is included in the AC-DC converter 303, and a CPLD 320 and an NIC 322 are included in the controller 3.

In the quick-off state, the FET 330 becomes OFF by a remote signal sent from the CPLD 320, and the NIC 322 and the CPU 201, which are connected to the FET 330 and are unnecessary to energize in the quick-off state, become OFF.

On the other hand, the memory 203 and the CPLD 320, which are necessary to energize in the quick-off state, keep ON.

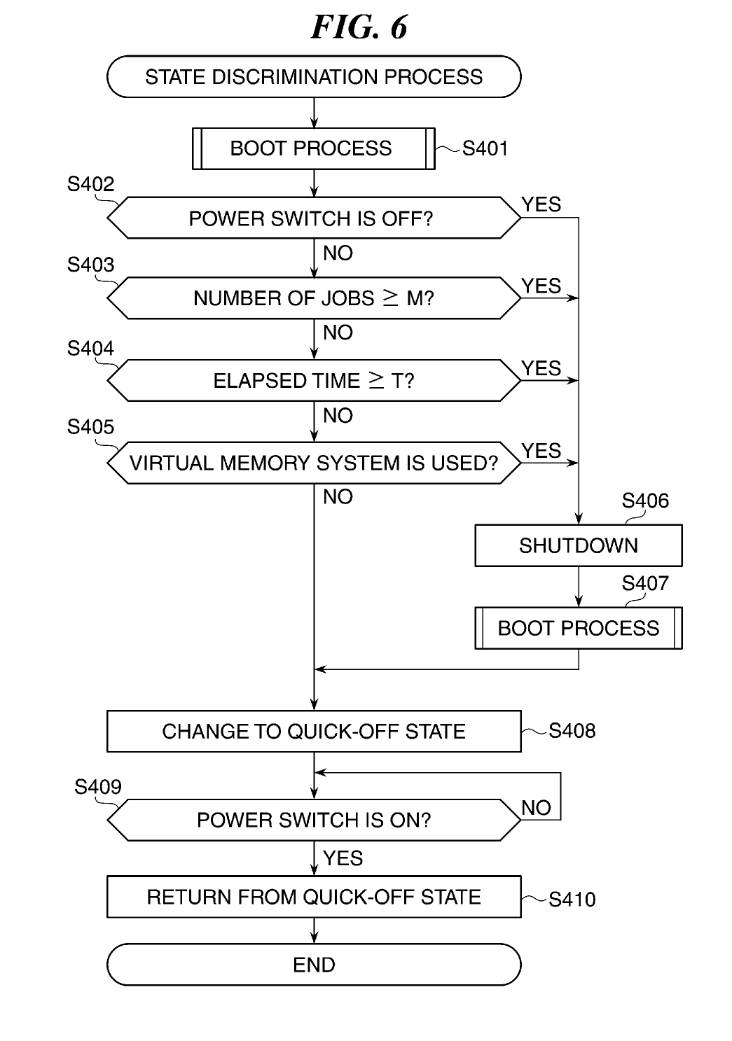

FIG. 6 is a flowchart showing a state discrimination process executed by the controller 3 in FIG. 1. The state discrimination process is executed when the power switch 301 is changed from ON to OFF.

A program for executing the state discrimination process shown in FIG. 6 is stored in the hard disk 6 or the flash disk 207.

As shown in FIG. 6, the controller 3 performs a boot process for starting the image forming apparatus 1 (step S401). Details of the boot process will be described below. After finishing the boot process and shifting to the working state, the controller 3 determines whether the power switch 301 is OFF (step S402).

When the power switch 301 is OFF (YES in the step S402), the controller 3 shuts down the image forming apparatus 1 (step S406). Next, the controller 3 performs the boot process mentioned above (step S407), and proceeds with the process to step S408.

On the other hand, when the power switch is not OFF (NO in the step S402), the controller 3 determines whether the number of jobs performed after starting is not smaller than a predetermined value M (step S403). In the step S403, the controller 3 determines a condition of fragmentation of use areas on a volatile storage unit (the memory 203) as the number of the image processes (jobs) performed by the present time after starting the image processing apparatus 1. This is because the fragmentation on the memory 203 probably increases as the number of executed jobs increases, in general.

The number of jobs is stored in the hard disk 6 or the flash disk 207. Since the predetermined value M varies depending on the specification and the operating environments of the image forming apparatus 1, it is suitably defined based on results of experiments etc.

When the number of jobs performed after starting is not smaller than the predetermined value M (YES in the step S403), the controller 3 shuts down the image forming apparatus 1 (step S406), executes a boot process (step S407), and proceeds with the process to step S408.

On the other hand, when the number of jobs performed after starting is smaller than the predetermined value M (NO in the step S403), the controller 3 determines whether elapsed time by the present time after starting is not smaller than a predetermined value T (step S404). In the step S404, the controller 3 determines a condition of fragmentation of use areas on the volatile storage unit as the elapsed time by the present time after starting the image processing apparatus 1. This is because the number of executed jobs and the fragmentation on the memory 203 probably increase as the elapsed time becomes longer, in general.

The elapsed time is stored in the hard disk 6 or the flash disk 207. Since the predetermined value T varies depending on the specification and the operating environments of the image forming apparatus 1, it is suitably defined based on results of experiments etc.

When the elapsed time after starting is not smaller than the predetermined value T (YES in the step S404), the process proceeds to the step S406.

On the other hand, when the elapsed time after starting is smaller than the predetermined value T (NO in the step S404), the controller 3 determines whether a virtual storage system was used after starting (step S405).

In the step S405, the controller 3 determines a condition of fragmentation of use areas on the volatile storage unit as the use or no-use of the virtual storage system. This is because the fragmentation on the memory 203 probably increases when the virtual storage system is used, in general.

When the virtual storage system was used (YES in the step S405), the process proceeds to the step S406.

On the other hand, when the virtual storage system was not used (NO in the step S405), the apparatus makes a transition to the quick-off state (step S408). Then, when the power switch 301 is turned ON (YES in step S409), the apparatus returns from the quick-off state (step S410), and this process is finished.

In the step S408, the controller 3 calls a power-saving I/F with which a kernel of the OS is provided to change the BIOS 602 and the power monitoring unit 603 to the ACPI-S3 state finally, and changes the power supply unit 302 to the ACPI-S3 state via the power remote line 308. In the ACPI-S3 state of the power supply unit 302, only the memory and a part of hardware units are energized.

In the state discrimination process in FIG. 6, when one of the three conditions shown in the steps S403, S404, and S405 is satisfied, the process branches to the step S406 and the shutdown process and the boot process are performed. Alternatively, the process may branch to the step S406 when two conditions, two or three conditions, or all conditions among the three conditions are fulfilled.

The steps S403, S404, and S405 correspond to a discrimination unit that discriminates whether fragmentation of use areas on the memory needs to be solved, when changing from the working state to the quick-off state.

The steps S407 and S408 correspond to a first transition unit that boots the image forming apparatus 1 after the image forming apparatus 1 makes a transition to the power OFF state, and then, makes a transition to the quick-off state (power saving mode).

The case where the process directly proceeds to the step S408 directly from the step S405 corresponds to a second transition unit that makes a transition to the quick-off state without making a transition to the power OFF state.

According to the state discrimination process in FIG. 6, when a user changes the image forming apparatus 1 from the available working state to the quick-off state with less power consumption than the working state, the controller 3 discriminates whether or not to make a transition to the power OFF state, based on the information about the volatile storage unit that the image forming apparatus 1 uses at the time of processing an image (steps S403, S404, and S405). Next, when discriminating to make a transition to the power OFF state (YES in the step S403, S404, or S405), the controller 3 shuts down the image forming apparatus 1 to make a transition to the power OFF state. Then, since the image forming apparatus 1 is started and is changed to the quick-off state after changing to the power OFF state, the fragmentation of use areas on the volatile storage unit used for processing an image can be controlled, and the unavailable time for a user who uses the image processing apparatus 1 can be shortened.

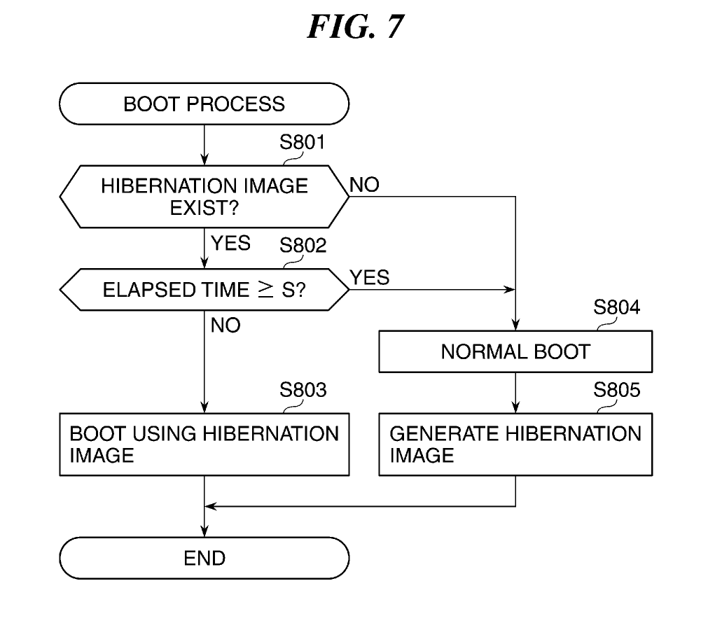

FIG. 7 is a flowchart showing the boot process executed in the step S407 in FIG. 6.

As shown in FIG. 7, the controller 3 determines whether a hibernation image exists (step S801). The hibernation image shows contents of the physical memory of the image forming apparatus 1, the information about the hardware units, register values, etc., and is stored in the hard disk 6.

When a hibernation image does not exist (NO in the step S801), the controller 3 boots up the apparatus normally (step S804), generates a hibernation image after starting (step S805), and finishes this process. The image forming apparatus 1 will be in the working state after finishing this process.

When a hibernation image exists (YES in the step S801) on the other hand, the controller 3 determines whether the time elapsed from generation of the hibernation image is not shorter than a predetermined value S (step S802). Since the predetermined value S varies depending on the specification and the operating environments of the image forming apparatus 1, it is suitably defined based on results of experiments etc.

When the time elapsed from generation of the hibernation image is not smaller than the predetermined value S (YES in the step S802), the process proceeds to the step S804.

When the time elapsed from generation of the hibernation image is smaller than the predetermined value S (NO in the step S802) on the other hand, the controller 3 boots up the image forming apparatus using the hibernation image (step S803), and finishes this process. The image forming apparatus 1 will be in the working state after finishing this process.

Since the hibernation image generation in the step S805 is performed immediately after starting normally, the hibernation image is generated based on the memory where the use area fragmentation hardly exists.

When the apparatus is started using the hibernation image in the step S803, the starting time is shorter than that of the normal boot in the step S804.

The hibernation image corresponds to the return information for making the image forming apparatus 1 return to the state when changing to the power OFF state. Specifically, the hibernation image includes the contents of the physical memory of the image forming apparatus at working, and hardware information. That is, when the hibernation image is used, there becomes no need to load programs required for the normal boot sequentially and to execute them, and initialization of the hardware can be omitted.

Thus, when the return information is stored in the hard disk 6 and the time elapsed after storing the return information is shorter than the predetermined time S, the apparatus makes a transition to the working state using the stored return information, in the boot process in FIG. 7.

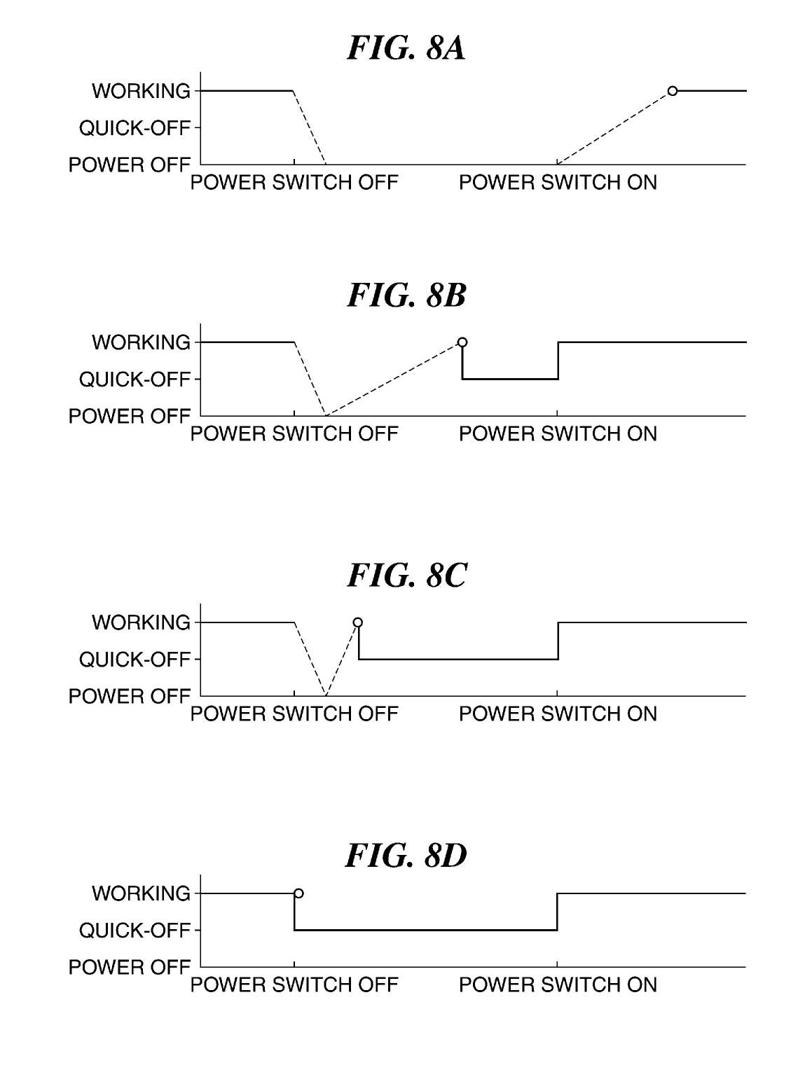

FIG. 8A through FIG. 8D are views showing electric power states of the image forming apparatus 1 when the power switch 301 is ON and OFF, respectively.

In FIG. 8A through FIG. 8D, a vertical axis shows an electric power state and a horizontal axis shows the elapsed time. A dotted line shows a state where the image forming apparatus 1 is unavailable. In the elapsed time after a circle mark, the image forming apparatus 1 will be available when the power switch 301 has been ON or turns ON.

FIG. 8A is a view showing an electric power state in a conventional image forming apparatus. As shown in FIG. 8A, when the power switch 301 turns OFF, the apparatus shuts down and makes a transition to the power off state, and when the power switch 301 turns ON, the apparatus makes a transition to the working state gradually. As shown in FIG. 8A, the image forming apparatus is not available immediately even when the power switch 301 turns ON.

FIG. 8B is a view showing an electric power state in an conventional image forming apparatus that can make a transition to the quick-off state. FIG. 8B shows that the shutdown and the normal boot are performed when the power switch 301 turns OFF and the apparatus returns from the quick-off state when the power switch 301 turns ON. As shown in FIG. 8B, the apparatus makes a transition to the quick-off state after the expiration of predetermined time from the turning OFF of the power switch 301. When the power switch 301 turns ON at that time, the image forming apparatus immediately becomes available.

FIG. 8C is a view showing an electric power state in the image forming apparatus 1 concerning the embodiment that can make a transition to the quick-off state. FIG. 8C shows that the shutdown and the hibernation boot are performed when the power switch 301 turns OFF and the apparatus returns from the quick-off state when the power switch 301 turns ON. As shown in FIG. 8C, the apparatus makes a transition to the quick-off state after the power switch 301 is turned OFF in time shorter than the case of the normal boot shown in FIG. 8B. When the power switch 301 turns ON at this timing, the image forming apparatus 1 becomes immediately available.

FIG. 8D is a view showing an electric power state in the image forming apparatus 1 concerning the embodiment that can make a transition to the quick-off state. FIG. 8D shows a case that does not need to shut down. The apparatus makes a transition to the quick-off state when the power switch 301 turns OFF, and returns from the quick-off state when the power switch 301 turns ON. As shown in FIG. 8B, when the power switch 301 turns ON in the quick-off state, the image forming apparatus 1 becomes immediately available.

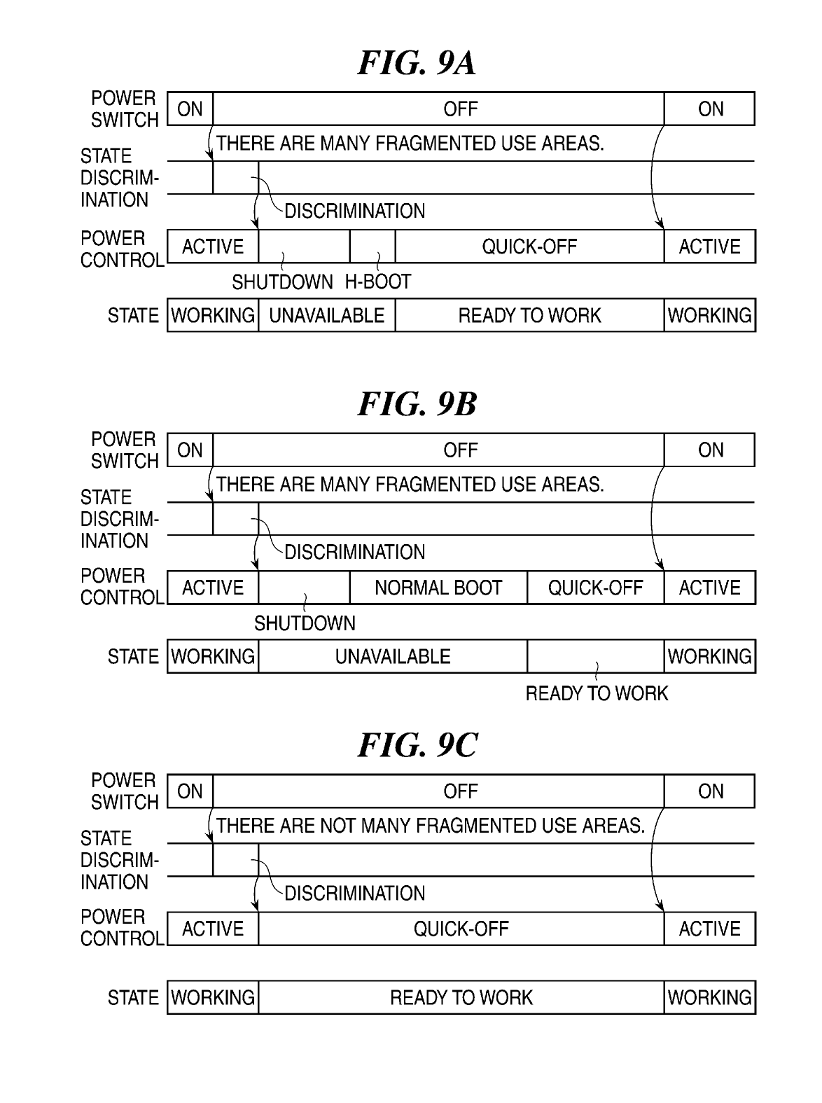

FIG. 9A, FIG. 9B, and FIG. 9C are timing charts showing a process performed in response to ON/OFF operations of the power switch 301.

FIG. 9A shows a timing chart in the case where the image forming apparatus 1 performs the hibernation boot.

As shown in FIG. 9A, when the power switch 301 turns OFF, the image forming apparatus 1 performs the state discrimination process. The state discrimination process is performed according to the state of fragmentation of the use areas on the memory 203 that the image forming apparatus 1 uses at the time for processing an image, as shown in FIG. 6.

As a result, when it is discriminated that many use areas are fragmented on the memory 203, the apparatus is shut down first. Then, the apparatus performs the hibernation boot (H-boot) and makes a transition to the quick-off state. When the power switch 301 turns ON, the image forming apparatus 1 makes a transition to the working state, a user becomes possible to use the image forming apparatus 1 immediately.

FIG. 9B shows a timing chart in the case where the image forming apparatus 1 boots up normally.

As shown in FIG. 9B, when the power switch 301 turns OFF, the image forming apparatus 1 performs the state discrimination process. As a result, when it is discriminated that many use areas are fragmented on the memory 203, the apparatus is shut down first. Then, the apparatus boots up normally and makes a transition to the quick-off state.

Accordingly, it takes longer time until changing to the quick-off state as compared with the case in FIG. 9A. Then, when the power switch 301 turns ON, the image forming apparatus 1 makes a transition to the working state, a user becomes possible to use the image forming apparatus immediately.

FIG. 9C shows a timing chart in the case where the image forming apparatus 1 makes a transition to the quick-off state without shutting down.

As shown in FIG. 9C, when the power switch 301 turns OFF, the image forming apparatus 1 performs the state discrimination process. As a result, when it is discriminated that many use areas are not fragmented on the memory 203, the apparatus makes a transition to the quick-off state without shutting down. Then, when the power switch 301 turns ON, the image forming apparatus 1 makes a transition to the working state, a user becomes possible to use the image forming apparatus 1 immediately.

The image forming apparatus 1 of this embodiment can solve the fragmentation of the memory by shutting down, when the user turns OFF the power switch 301 and it is discriminated that there are many fragmented use areas, as shown in FIG. 9A. Since the hibernation boot is usually performed, the starting time becomes shorter than that of the normal boot.

Since the apparatus makes a transition to the quick-off state after the hibernation boot, the user can use the image forming apparatus 1 immediately. Exceptionally, when a hibernation image is not generated, or when the time elapsed after generation is more than the predetermined value S, the apparatus boots up normally.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-271128, filed on Dec. 12, 2011, which is hereby incorporated by reference herein in its entirety.

What is claimed is:

1. An information processing apparatus that has a volatile first memory and a nonvolatile second memory, comprising:
a first control unit configured to start the information processing apparatus without using a hibernation image when a hibernation image is not stored in the second memory at the time of starting the information processing apparatus, and to generate a hibernation image in the second memory;
a second control unit configured to start the information processing apparatus while using a hibernation image when the hibernation image is stored in the second memory at the time of starting the information processing apparatus; and
a third control unit configured to change a state of the information processing apparatus to a power saving state while keeping power supply to the first memory in response to completion of the starting of the information processing apparatus.

2. The image processing apparatus according to claim 1, wherein said second control unit starts the information processing apparatus without using the hibernation image when time elapsed from generation of the hibernation image exceeds a predetermined value even when the hibernation image is stored in the second memory at the time of starting the information processing apparatus, and generates a hibernation image in the second memory again.

3. The image processing apparatus according to claim 1, wherein said second control unit restarts the information processing apparatus when the number of jobs performed after starting exceeds a predetermined value.

4. The image processing apparatus according to claim 1, wherein said second control unit restarts the information processing apparatus when the time elapsed after starting exceeds a predetermined value.

5. The image processing apparatus according to claim 1, wherein said second control unit restarts the information processing apparatus when a virtual storage system was used after starting.

6. A control method for an information processing apparatus that has a volatile first memory and a nonvolatile second memory, the control method comprising:
a first control step of starting the information processing apparatus without using a hibernation image when a hibernation image is not stored in the second memory at the time of starting the information processing apparatus, and of generating a hibernation image in the second memory;
a second control step of starting the information processing apparatus while using a hibernation image when the hibernation image is stored in the second memory at the time of starting the information processing apparatus; and
a third control step of changing a state of the information processing apparatus to a power saving state while keeping power supply to the first memory in response to completion of the starting of the information processing apparatus.

7. A non-transitory computer-readable storage medium storing a control program causing a computer to execute a control method for an image processing apparatus that has a volatile first memory and a nonvolatile second memory, the control method comprising:
a first control step of starting the information processing apparatus without using a hibernation image when a hibernation image is not stored in the second memory at the time of starting the information processing apparatus, and of generating a hibernation image in the second memory;
a second control step of starting the information processing apparatus while using a hibernation image when the hibernation image is stored in the second memory at the time of starting the information processing apparatus; and
a third control step of changing a state of the information processing apparatus to a power saving state while keeping power supply to the first memory in response to completion of the starting of the information processing apparatus.
